(19) United States
(12) Patent Application Publication
(10) Pub. No.: US 2011/0259874 A1
(43) Pub. Date: Oct. 27, 2011

(54) Flat Heating Apparatus

(76) Inventor: LIANG-YUN LAI, Taichung City (TW)

(21) Appl. No.: 12/765,716

(22) Filed: Apr. 22, 2010

(51) Int. Cl. H05B 3/34

(52) U.S. Cl. 219/529; 219/520

(57) ABSTRACT

A flat heating apparatus includes a plank, at least one heater, at least one wire and a metal foil. The plank includes a vacuum chamber defined therein and at least one groove defined in an upper face thereof. The heater is located in the groove. The wire is directed through the heater and extended from the plank. The metal foil is provided on the plank so that the heater is located between the metal foil and the plank.

### BACKGROUND OF INVENTION

1. Field of Invention

The present invention relates to a flat heating apparatus for use in a building.

2.Related Prior Art

Referring to FIGS. 5 and 6, a conventional thermally insulating plank 20 is made of a foam material and therefore includes bubbles 21. The thermally insulating plank 20 is provided on a floor A. A heater 23 is provided on the thermally insulating plank 20. The heater 23 is a hot water pipe or an electro-thermal wire. A concrete layer is provided on the thermally insulating plank 20 so that the heater 23 is located in the concrete layer. A decorative plank 24 is provided on the concrete layer. The decorative plank 24 is a wood plank, a marble tile or a ceramic tile. Heat provided from the heat 23 is better insulated by the air in the bubbles 21 than by the foam material of the thermally insulating plank 20. A first portion of the heat goes to the interior 25 of a building from the heater 23 via the concrete layer and the decorative layer 24, and a second portion of the heat inevitably goes to the floor A from the heater 23 through the thermally insulating plank 20 as indicated with arrow heads 22.

Several problems are encountered during the use of the thermally insulating plank 20. Firstly, the second portion of the heat is wasted.

Secondly, the thermally insulating plank 20 needs a large number of bubbles 21 to provide excellent thermal insulation. Hence, the thermally insulating plank 20 is thick and wastes the space of the interior 25.

Thirdly, leak is inevitable after some time of use where the heater 23 is a hot water pipe.

Fourthly, the concrete layer is thick to embed the heater 23 made with a diameter larger generally than 20 millimeters where the heater 23 is a hot water pipe. The concrete layer wastes the space of the interior 25. If a heater made with a smaller diameter is used, such a heater must be longer and requires a higher hydraulic pressure for pumping hot water trough it. These changes however increase the risks of leak.

Fifthly, the provision of the concrete layer is troublesome. Moreover, it takes quite some time for the concrete layer to cure before the decorative plank 24 can be provided on the thermally insulating plank 20 where the decorative plank 24 is a wood plank.

Sixthly, the first portion of the heat goes through the decorative plank 24 unevenly. The first portion of the heat might cause the concrete layer to crack if the thickness of the concrete layer is inadequate or the provision of the concrete layer is poor.

Seventhly, the heater 23 is made of a fixed size where the heater 23 is an electro-thermal wire. The heater 23 cannot be cut or connected to another heater 23. Therefore, heaters made with various sizes must be stored, and this practice causes a serious problem with the inventory.

The present invention is therefore intended to obviate or at least alleviate the problems encountered in prior art.

### SUMMARY OF INVENTION

According to the present invention, there is provided a flat heating apparatus including a plank, at least one heater, at least one wire and a metal foil. The plank includes a vacuum chamber defined therein and at least one groove defined in an upper face thereof. The heater is located in the groove. The wire is directed through the heater and extended from the plank. The metal foil is provided on the plank so that the heater is located between the metal foil and the plank.

The thermally insulating plank of the present invention exhibits several advantages. Firstly, it transfers almost all of the heat produced by the heaters to the interior of a building by thermally insulating the heat from a floor.

Secondly, it transfers the heat to a decorative plank provided on the flat heating apparatus foil evenly through the metal foil.

Thirdly, the provision of the flat heating apparatus is easy.

Fourthly, the calculation of the power of a system consisting of several flat heating apparatuses is precise.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a flat heating apparatus according to the preferred embodiment of the present invention;

FIG. 2 is a partial view of the flat heating apparatus shown in FIG. 1;

FIG. 3 is a front view of the flat heating apparatus shown in FIG. 1;

FIG. 4 is a top view of several flat heating apparatuses as the one that is shown in FIG. 1;

FIG. 5 is a perspective view of a conventional heater and a conventional thermally insulating plank; and

FIG. 6 is a cut-away view of the conventional heater and the conventional thermally insulating plank shown in FIG. 5.

### DETAILED DESCRIPTION OF PREFERRED EMBODIMENT

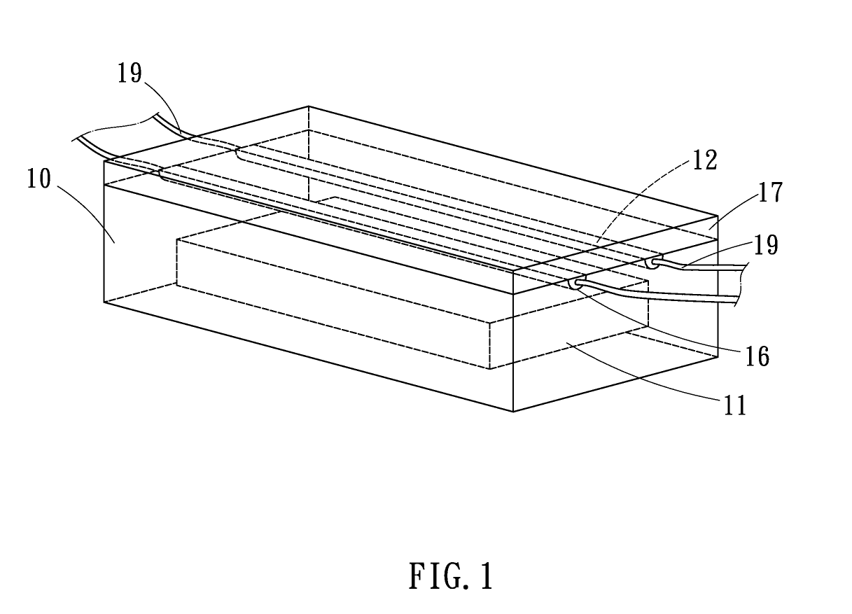

Referring to FIG. 1, a flat heating apparatus includes two heaters 12, a metal foil 17 and a thermally insulating plank 10 according to the preferred embodiment of the present invention. The thermally insulating plank 10 includes a vacuum chamber 11 defined therein. The thermally insulating plank 10 further includes two grooves 16 defined in an upper face thereof. The thermally insulating plank 10 can be made of at least one material selected from the group consisting of plastics, rubber, metal, fabrics, paper, wood, ceramics, glass and cement. The degree of vacuum in the vacuum chamber is 0 to 760 mmHg.

Each of the heaters 12 is provided in a related one of the grooves 16. A wire 19 is directed through each of the heaters 12. The wires 19 are exposed to the exterior of the thermally insulating plank 10. The heaters 12 can be electro-thermal wires, electro-thermal films or any other proper heaters.

The metal foil 17 is provided on and attached to the thermally insulating plank 10. Thus, the heaters 12 are retained in the grooves 16. The metal foil 17 is made of at least one highly thermally conductive material selected from the group consisting of aluminum, silver and copper.

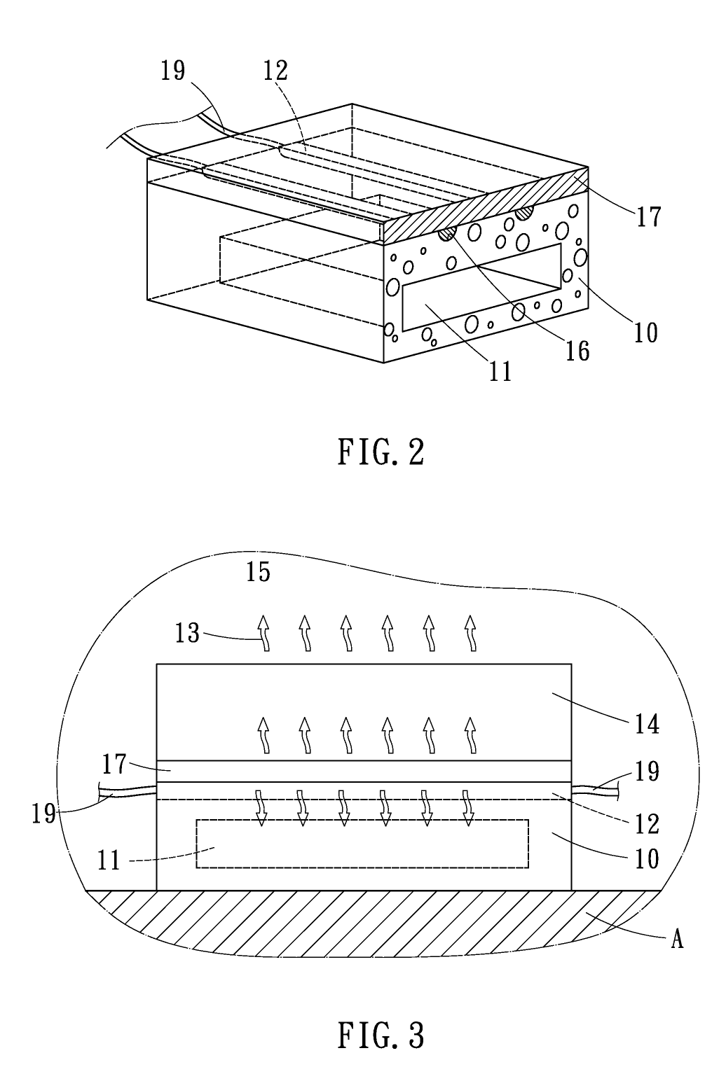

Referring to FIGS. 2 and 3, the flat heating apparatus is provided on a floor A before a decorative plank 14 such as a wood plank, a marble tile or a ceramic tile is provided on the flat heating apparatus. In detail, the thermally insulating plank 10 is provided on the floor A. The decorative plank 14 is provided on the metal foil 17. The vacuum chamber 11 is located between the heaters 12 and the floor A.

The heaters 12 produce heat as indicated with arrow heads 13. The heat is thermally insulated from the floor A because of the vacuum chamber 11. Hence, almost all of the heat is transferred to the interior 15 of a building through the metal foil 17 and the decorative plank 14. The heat is evenly spread in the metal foil 17 before it is transferred to the decorative plank 14.

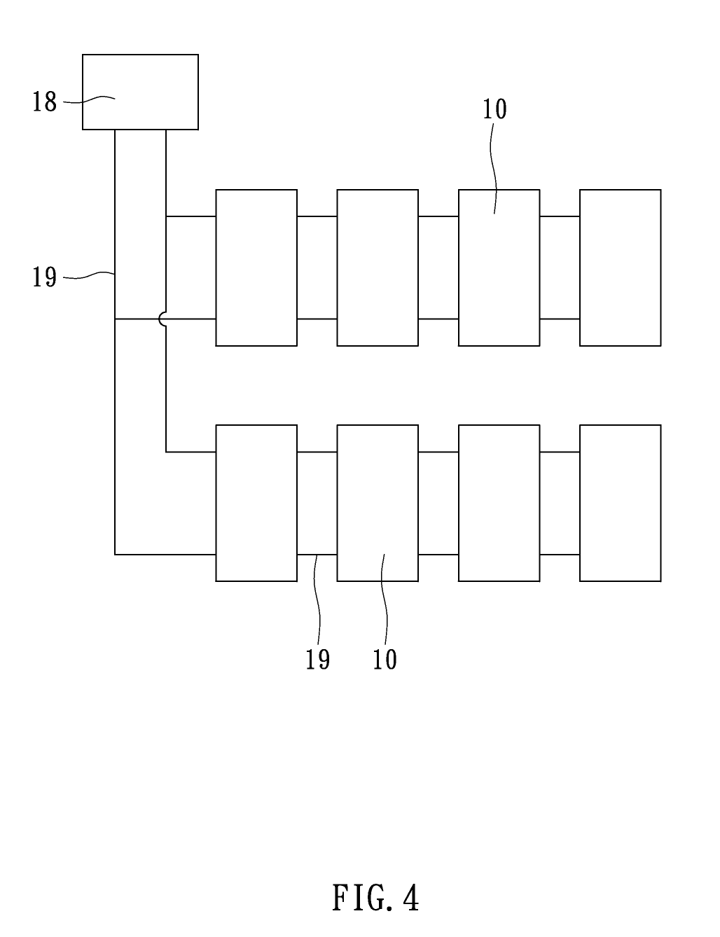

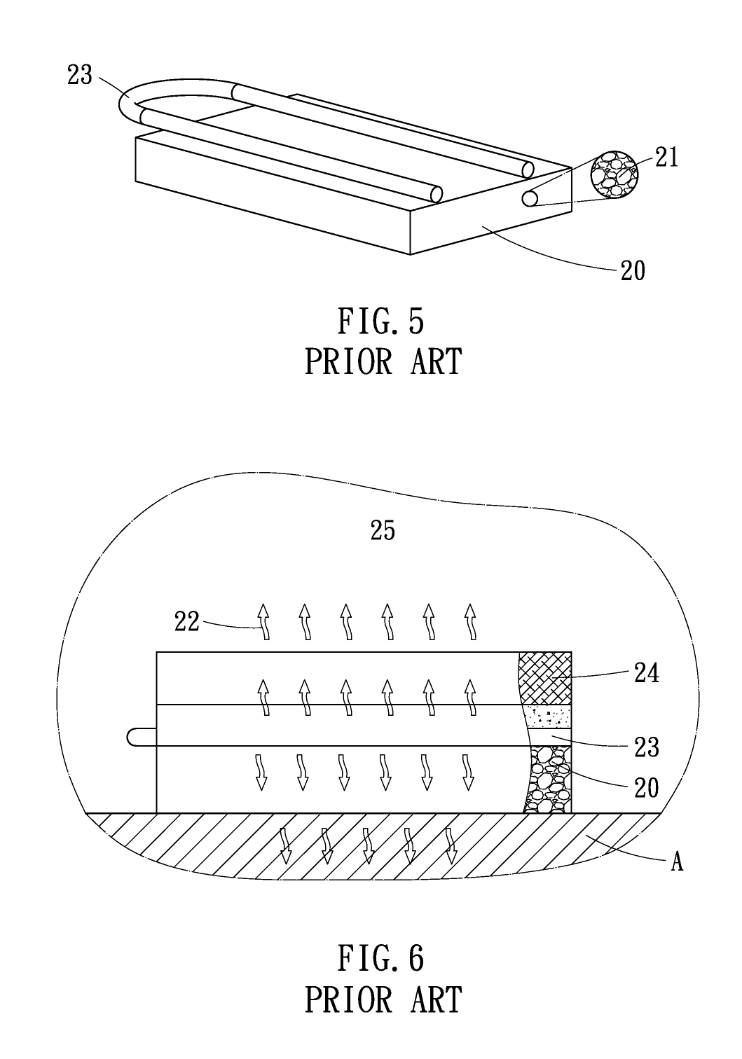

Referring to FIG. 4, a plurality of flat heating apparatuses as the one shown in FIGS. 1 to 3 is used. The heaters 12 are electrically connected in parallel through the wires 19. The heaters 12 are connected to a temperature controller 18. The operation of the system consisting of the flat heating apparatuses is under the control of the temperature controller 18.

The flat heating apparatus of the present invention exhibits several advantages. Firstly, it transfers almost all of the heat to the interior 15 by thermally insulating the heat from the floor A.

Secondly, it transfers the heat to the decorative plank 14 evenly through the metal foil 17.

Thirdly, the provision of the flat heating apparatus is easy.

Fourthly, the calculation of the power of the system consisting of the flat heating apparatuses is precise.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A flat heating apparatus including:
a plank including a vacuum chamber defined therein and at least one groove defined in an upper face thereof;
at least one heater located in the groove;
at least one wire directed through the heater and extended from the plank; and
a metal foil provided on the plank so that the heater is located between the metal foil and the plank.

2. The flat heating apparatus according to claim 1, wherein the degree of vacuum in the vacuum chamber is 0 to 760 mmHg.

3. The flat heating apparatus according to claim 1, wherein the metal foil is made of at least one material selected from the group consisting of aluminum, silver and copper.

4. The flat heating apparatus according to claim 1, wherein the heater is an electro-thermal wire.

5. The flat heating apparatus according to claim 1, wherein the heater is an electro-thermal film.

6. The flat heating apparatus according to claim 1, wherein the plank is made of plastics.

7. The flat heating apparatus according to claim 1, wherein the plank is made of rubber.

8. The flat heating apparatus according to claim 1, wherein the plank is made of metal.

9. The flat heating apparatus according to claim 1, wherein the plank is made of fabrics.

10. The flat heating apparatus according to claim 1, wherein the plank is made of paper.

11. The flat heating apparatus according to claim 1, wherein the plank is made of wood.

12. The flat heating apparatus according to claim 1, wherein the plank is made of ceramics.

13. The flat heating apparatus according to claim 1, wherein the plank is made of glass.

14. The flat heating apparatus according to claim 1, wherein the plank is made of cement.

15. The flat heating apparatus according to claim 1, wherein the plank is made of at least one material selected from the group consisting of plastics, rubber, metal, fabrics, paper, wood, ceramics, glass and cement.
